(19) United States
(12) Patent Application Publication
(10) Pub. No.: US 2024/0100888 A1
(43) Pub. Date: Mar. 28, 2024

(54) PNEUMATIC TIRE

(71) Applicant: Sumitomo Rubber Industries, Ltd., Kobe-shi (JP)

(72) Inventors: Yoshihiro YAMADA, Kobe-shi (JP); Yuta SAKAKIBARA, Kobe-shi (JP); Naoki ISHIDA, Kobe-shi (JP); Yuya MEGURO, Kobe-shi (JP)

(73) Assignee: Sumitomo Rubber Industries, Ltd., Kobe-shi (JP)

(21) Appl. No.: 18/373,993

(22) Filed: Sep. 28, 2023

(30) Foreign Application Priority Data
Sep. 28, 2022 (JP) 2022-155364

(51) Int. Cl. B60C 13/00; B60C 13/02

(52) U.S. Cl. CPC B60C 13/001; B60C 13/02

(57) ABSTRACT

A pneumatic tire can include a pair of sidewall portions, where an outer surface of the sidewall portion can include a marking portion. The marking portion can include a first region forming a mark, a second region that is a background portion of the mark, and a fringing portion that demarcates the first region from the second region and fringes the contour of the mark. The first region can be formed as a smooth surface. The second region can be a projection-recess region where a plurality of micro projections are arranged. The fringing portion can be a rib projecting from the first region.

### CROSS-REFERENCE TO RELATED APPLICATION

The present application claims priority to Japanese patent application JP2022-155364, filed on Sep. 28, 2022, the entire contents of which are incorporated herein by reference in its entirety.

### BACKGROUND

### Field

The present disclosure relates to a pneumatic tire.

### Background Art

Japanese Laid-Open Patent Publication No. 2020-125045 proposes a tire having a recessed mark provided on a sidewall portion. In the tire, a bottom surface of the recessed mark is divided into a shadow region where a shadow is formed by a wall portion of the recessed mark and a main region other than the shadow region. The shadow region has a plurality of micro projections to impart contrast between the shadow region and the main region.

In the tire in Japanese Laid-Open Patent Publication No. 2020-125045, part of the contour of the main region is defined by the micro projections adjacent thereto, and thus the contour may not be regarded as smooth, so that the appearance may tend to deteriorate.

### SUMMARY

An aspect of the present disclosure is directed to a pneumatic tire including a pair of sidewall portions. In the pneumatic tire, at least one of outer surfaces of the pair of sidewall portions includes at least one marking portion, the marking portion includes a first region forming a mark including at least one character, at least one graphic, or at least one symbol, a second region that is a background portion of the mark, and a fringing portion that demarcates the first region from the second region and fringes a contour of the mark, the first region is formed as a smooth surface, the second region is a projection-recess region where a plurality of micro projections are arranged, and the fringing portion is a rib projecting from the first region.

### BRIEF DESCRIPTION OF THE DRAWINGS

FIG. 1 is an enlarged perspective view of a sidewall portion of a tire according to an embodiment;

FIG. 2 is an enlarged view of a marking portion in FIG. 1;

FIG. 3 is an enlarged perspective view of a region A in FIG. 2;

FIG. 4 is a sectional view taken along a B-B line in FIG. 2;

FIG. 5 is an enlarged plan view of a part of a second region; and

FIG. 6 is an enlarged perspective view conceptually showing the positional relationship between a rib and a plurality of micro projections.

### DETAILED DESCRIPTION

The present disclosure and one or more embodiments thereof have been made in view of the above circumstances in the Background section, and an object of one or more embodiments of the present disclosure, among one or more objects, can be to provide a pneumatic tire having improved appearance of a marking portion on a sidewall portion.

As a result of adopting configurations according to one or more embodiments of the present disclosure, the pneumatic tire can improve the appearance of the marking portion of the sidewall portion.

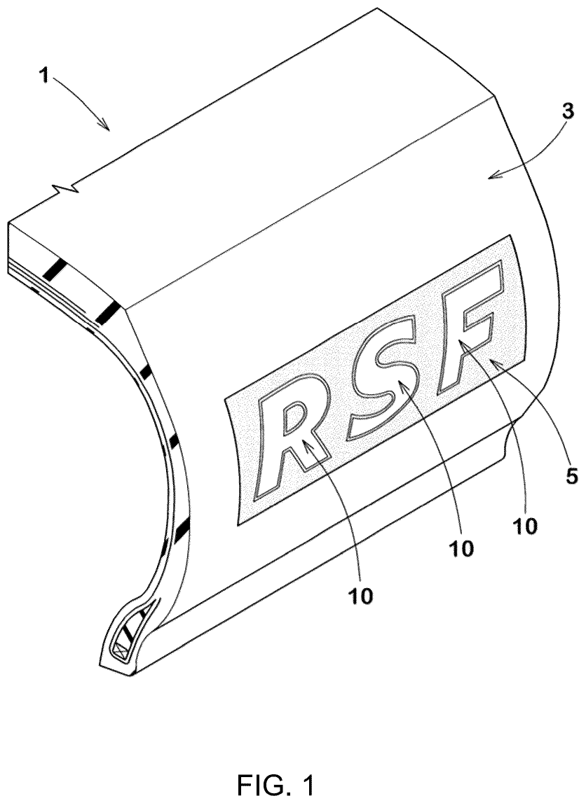

Hereinafter, one embodiment of the present disclosure will be described with reference to the drawings. FIG. 1 is an enlarged perspective view of a sidewall portion 3 of one embodiment of a pneumatic tire 1 (hereinafter, also referred to simply as “tire 1”) according to one or more embodiments of the present disclosure. The tire 1 can have a pair of sidewall portions 3, where FIG. 1 shows a part of an outer surface of one of the sidewall portions 3. As shown in FIG. 1, the tire 1 can be, for example, a pneumatic tire for a passenger car. Embodiments of present disclosure, however, may be applied to or implemented in or as a motorcycle tire or a heavy-duty tire, for example.

In the description herein, unless otherwise specified, dimensions of components of the tire 1 are measured in the standardized state. The “standardized state” can represent a state in which a tire is fitted on a standardized rim and is inflated to a standardized internal pressure and no load is applied to the tire when the tire is a pneumatic tire for which various standards are defined. For tires for which various standards are not defined, the standardized state can represent a standard use state, corresponding to a purpose of use of the tire, in which no load is applied to the tire.

The “standardized rim” can represent a rim that is defined by a standard for each tire, in a standard system including the standard on which the tire is based, and can be, for example, “standard rim” in the JATMA standard, “Design Rim” in the TRA standard, or “Measuring Rim” in the ETRTO standard.

The “standardized internal pressure” can represent an air pressure that is defined by a standard for each tire, in a standard system including the standard on which the tire is based, and can be “maximum air pressure” in the JATMA standard, the maximum value recited in the table “TIRE LOAD LIMITS AT VARIOUS COLD INFLATION PRESSURES” in the TRA standard, or “INFLATION PRESSURE” in the ETRTO standard.

As shown in FIG. 1, the sidewall portion 3 can have a visible outer surface. The visible outer surface can be a surface that is visible from the outside when the tire 1 is used. At least one of the outer surfaces of the pair of sidewall portions 3 can be provided with at least one marking portion 5. A mark 10 can be formed on the marking portion 5. The mark 10 includes at least one character, at least one graphic, or at least one symbol. The mark 10 of the present embodiment includes “R”, “S”, and “F” as one example, but embodiments of the present disclosure are not limited thereto. According to one or more embodiments, a plurality of marks 10 can be implemented, for instance, the “R”, “S”, and “F” shown in FIG. 1.

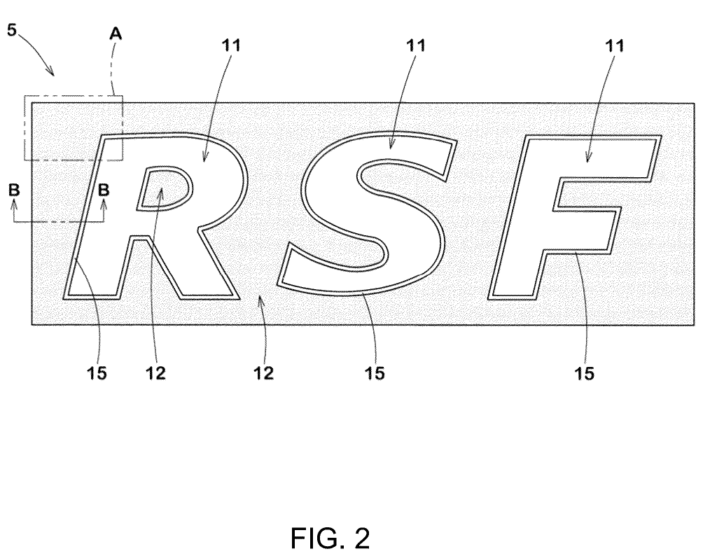

FIG. 2 is an enlarged view of the marking portion 5 in FIG. 1. As shown in FIG. 2, the marking portion 5 can includes a first region 11 forming the mark 10, a second region 12 that is a background portion of the mark 10, and a fringing portion 15 that demarcates the first region 11 from the second region 12 and fringes or outlines the contour of the mark 10. In FIG. 2, the first region 11 is shown as a blank region, and the second region 12 is dotted. The fringing portion 15 is shown by thin double lines.

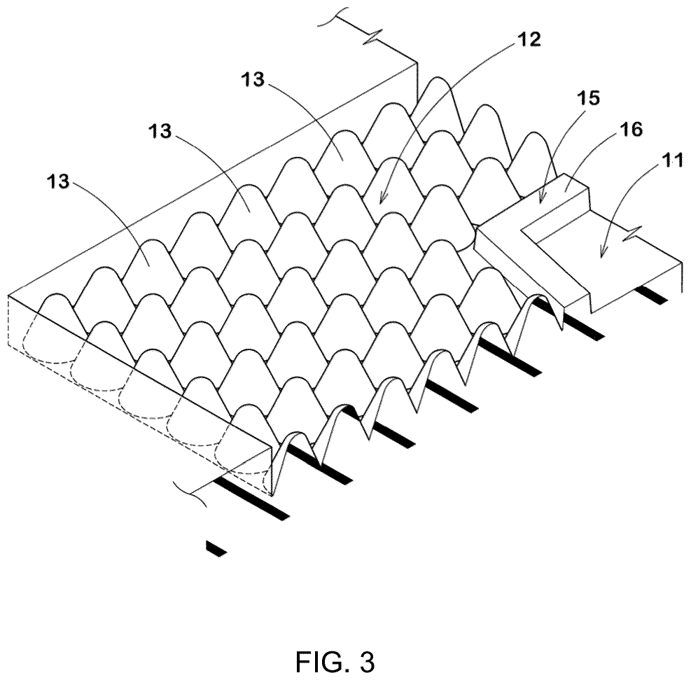

FIG. 3 is an enlarged perspective view of a region A in FIG. 2. As shown in FIG. 3, the first region 11 can be formed as a smooth surface. On the other hand, the second region 12 can be a projection-recess region where a plurality of micro projections 13 are arranged. The smooth surface of the first region 11 can mean an even surface enabling a sufficient contrast to be imparted with respect to the second region 12 described below. In a preferable aspect, the first region 11 can have an arithmetic mean roughness Ra of not greater than 50 μm, for example.

The fringing portion 15 according to one or more embodiments of the present disclosure can be a rib 16 projecting from the first region 11. The “rib” can be a protrusion projecting with respect to the first region 11, and can means one that continuously extends along the contour of the mark 10 to have a longitudinal direction. Owing to the above-described configuration, embodiments of the present disclosure can improve the appearance of the marking portion 5 (shown in FIG. 1) of the sidewall portion 3. A reason for this can be as follows.

As shown in FIG. 2 and FIG. 3, according to one or more embodiments of the present disclosure, the first region 11 can be a smooth surface, for instance, so that more light can be reflected to cause the first region 11 to look pale, but the plurality of micro projections 13 (e.g., as shown in FIG. 3) can inhibit reflection of light on the second region 12, for instance, to cause the second region 12 to look darker. Accordingly, the contrast between the first region 11 and the second region 12 can be increased, which can improve the visibility and the appearance of the mark 10. In addition to this, according to one or more embodiments of the present disclosure, the fringing portion 15 can be a rib projecting form the first region 11, and thus can prevent the contour of the mark 10 from forming an irregular wavy line, which can improve the appearance of the marking portion 5.

In a conventional art, to prevent the contour of a mark from forming an irregular wavy line, a plurality of micro projections may be arranged at equal intervals along the contour of a first region. However, in such a method, an arrangement of the micro projections may need to be determined for each mark, which may increase cost in design or processing of a vulcanization mold for a tire. In addition, the above method, when the above method is performed on a mark including a curved line, a region where arrangement pitches of the micro projections are narrow and a region where arrangement pitches of the micro projections are wide may be generated, and thus the appearance may tend to deteriorate. According to one or more embodiments of the present disclosure, the above-described fringing portion 15 can be disposed, for instance, so that such a defect in the conventional art can be avoided.

Hereinafter, more detailed configurations of the present embodiment will be described. The configurations described below show a specific aspect of the present embodiment. Therefore, it is needless to say that one or more embodiments of the present disclosure can achieve the above-described effect even when the configurations described below are not provided. In addition, even when any one of the configurations described below is independently applied to the tire 1 according to one or more embodiments of the present disclosure having the above-described characteristics, performance improvement corresponding to each configuration can be expected. Furthermore, when some of the configurations described below are applied in combination, complex performance improvement corresponding to each configuration can be expected.

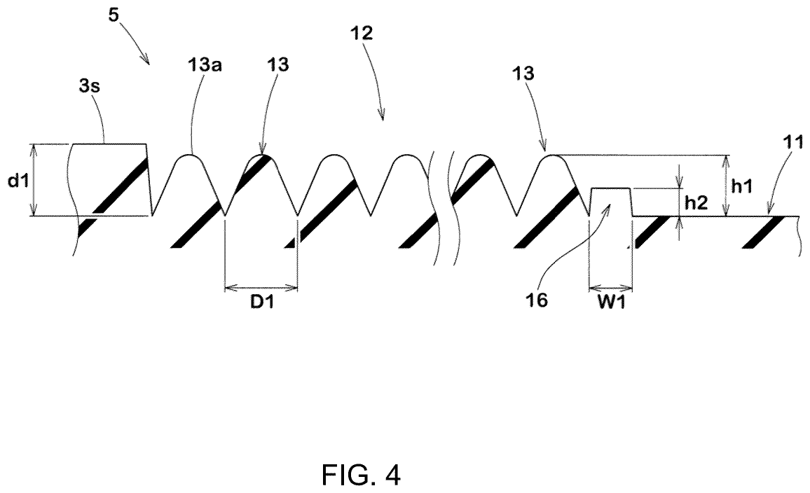

FIG. 4 is a sectional view of the marking portion 5. FIG. 4 corresponds to a sectional view taken along a B-B line in FIG. 2. As shown in FIG. 4, the marking portion 5 can be preferably recessed with respect to a reference surface 3s of the outer surface of the sidewall portion 3 (shown in FIG. 1), for example. Accordingly, the appearance of the mark 10 (shown in FIG. 1) can be improved, and a rubber volume of the sidewall portion 3 can be inhibited from increasing. However, one or more embodiments of the present disclosure are not limited thereto.

From the viewpoint of ensuring the durability of the sidewall portion 3, a recessed amount dl of the marking portion 5 with respect to the reference surface 3s can be preferably not larger than 1.5 mm.

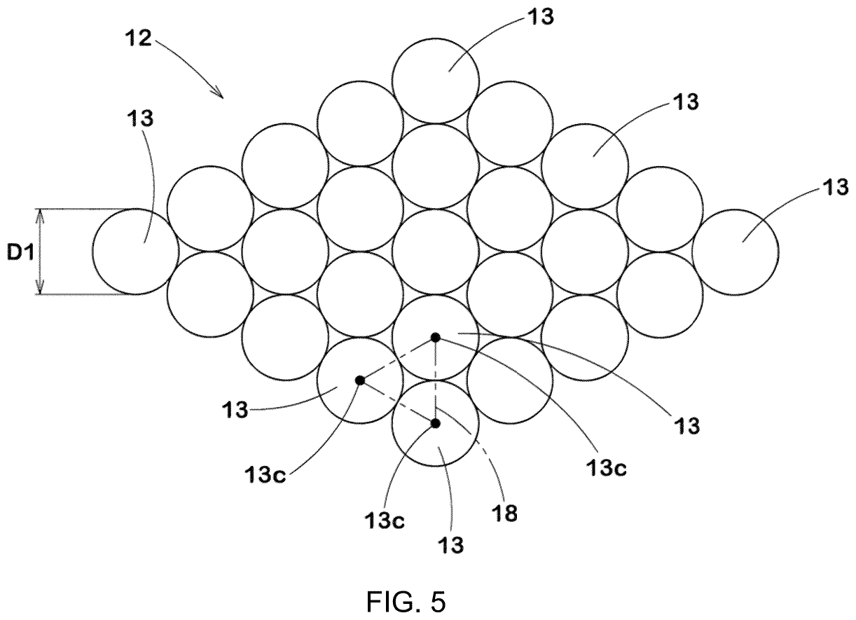

FIG. 5 is an enlarged plan view of a part of the second region 12. As shown in FIG. 5, the second region 12 can preferably include a portion where the plurality of micro projections 13 are arranged so as to form closest packing in a planar view. Accordingly, the amount of light reflected on the second region 12 can be further decreased, the contrast with the first region 11 can be increased, and thus the appearance of the marking portion 5 can be improved.

The above-described “closest packing” can at least mean that the micro projections 13 are densely arranged in a state in which another micro projection 13 cannot be additionally arranged, for instance, because the contours of the adjacent micro projections 13 are in contact with each other. In the present embodiment, the contour of each micro projection 13 can have a circular shape having a first maximum outer diameter D1, and the micro projections 13 can be arranged so as to form closest packing. Accordingly, in a planar view of the second region 12, a virtual triangle 18 with centers 13c of the contours of three micro projections 13 adjacent to each other, as apexes, can be an equilateral triangle. However, the arrangement of the micro projections 13 in the second region 12 of one or more embodiments of the present disclosure are not limited thereto.

In the second region 12, according to one or more embodiments of the present disclosure, less than five micro projections 13 can be arranged per mm², and preferably one to four micro projections 13 can be arranged. Accordingly, the appearance of the marking portion 5 can be further improved.

As shown in FIG. 3 and FIG. 4, each micro projection 13 can be formed as a truncated cone in which an upper surface 13a (shown in FIG. 4) is composed of a curved surface. However, the micro projection 13 according to one or more embodiments of the present disclosure are not limited thereto, and various forms such as a cone shape and a cylinder shape can be used. In another embodiment, in the upper surface 13a of the micro projection 13, a local recess may be provided. Such micro projections 13 can further inhibit the reflection of light on the second region 12.

As shown in FIG. 4, the first maximum outer diameter D1 of each micro projection 13 can be, for example, 0.3 to 1.0 mm, and preferably 0.5 to 0.7 mm. A maximum height h1 of the micro projection 13 with respect to the first region 11 can be preferably smaller than the recessed amount dl of the marking portion 5. Specifically, the height h1 is 0.3 to 1.0 mm, and preferably 0.4 to 0.8 mm. However, the micro projection 13 according to one or more embodiments of the present disclosure is not limited thereto.

The shape of a transverse cross-section of the rib 16 formed as the fringing portion 15 can be, for example, a trapezoidal shape. However, the shape of the transverse cross-section is not limited thereto, and may be a triangular shape or a semi-circular shape, as other examples. In addition, the rib 16 can have a maximum rib width W1 orthogonal to the longitudinal direction thereof. The rib width W1 can be preferably larger than ½ of the first maximum outer diameter D1 of the micro projection 13. Accordingly, the rib 16 can be easily visually recognized, and the appearance of the mark 10 can be further improved. On the other hand, when the rib width W1 is excessively large, the contour of the mark 10 may be unclear. Accordingly, the rib width W1 can be preferably smaller than the first maximum outer diameter D1, and specifically not larger than 70% of the first maximum outer diameter D1.

From the same viewpoint, a maximum height h2 of the rib 16 with respect to the first region 11 can be preferably not smaller than 10% of the maximum height hl of the plurality of micro projections 13 with respect to the first region 11, preferably not larger than 80% thereof, and more preferably not larger than 50% thereof.

From the viewpoint of clarifying the contour of the mark 10, preferably, the plurality of micro projections 13 adjacent to the rib 16 can be orderly arranged along the longitudinal direction of the rib 16. However, depending on the shape of the mark 10, when such an arrangement is maintained, cost in design or processing of a vulcanization mold for a tire may be increased. From the viewpoint of reducing the cost, the plurality of micro projections 13 may include a micro projection 13 that is not directly connected to the rib 16, or a micro projection 13 that is partially connected to the rib 16.

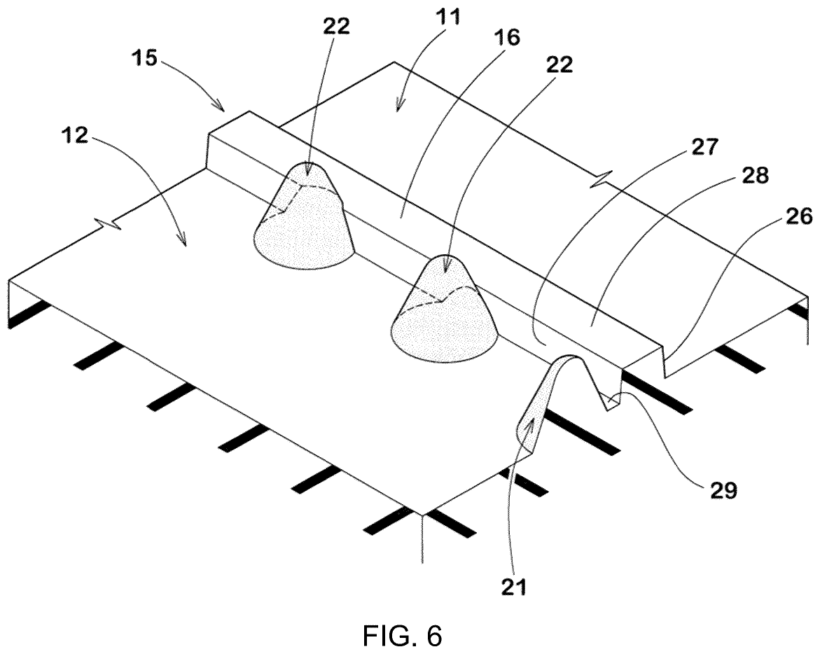

FIG. 6 is an enlarged perspective view conceptually showing the positional relationship between the rib 16 and the plurality of micro projections 13. In FIG. 6, for easy understanding of the positional relationship, only one rib 16 and three micro projections 13 are shown, but it is needless to say that many more micro projections 13 can actually be arranged so as to be adjacent to the rib 16. In FIG. 6, the outer face of each micro projection 13 is dotted.

As shown in FIG. 6, the plurality of micro projections 13 may include first projections 21 that are not directly connected to the rib 16 and second projections 22 that are partially connected to the rib 16. On the other hand, the rib 16 can include a first side surface 26 on the first region 11 side, a second side surface 27 on the second region 12 side, and a top face 28 between the first side surface 26 and the second side surface 27. The first projection 21 may not be connected to any of the surfaces of the rib 16. However, the smaller a gap 29 between the rib 16 and the first projection 21 may be, the larger the contrast between the rib 16 and the second region 12 may be. From this viewpoint, the length of the gap 29 (minimum length between the first projection 21 and the rib 16 at the root) can be preferably smaller than a minimum width of the top face 28 of the rib 16.

Meanwhile, each second projection 22 can be connected only to the second side surface 27 of the rib 16, or to both the second side surface 27 and the top face 28. Preferably, the second projection 22 can be, at least, not connected to the first side surface 26. Accordingly, the first side surface 26 can be clearly observed as a contour line of the mark 10, an increase in cost in design or processing of a vulcanization mold for a tire can be avoided, and the appearance of the mark 10 (shown in FIG. 1) can also be improved.

Embodiments of present are not limited to the above specific embodiments, and various modifications can be made.

### Additional Note

One or more embodiments of present disclosure can include some or all the following aspects.

### Disclosure 1

A pneumatic tire including a pair of sidewall portions, wherein

at least one of outer surfaces of the pair of sidewall portions includes at least one marking portion,

the marking portion includes a first region forming a mark including at least one character, at least one graphic, or at least one symbol, a second region that is a background portion of the mark, and a fringing portion that demarcates the first region from the second region and fringes a contour of the mark,

the first region is formed as a smooth surface,

the second region is a projection-recess region where a plurality of micro projections are arranged, and

the fringing portion is a rib projecting from the first region.

### Disclosure 2

The pneumatic tire according to Disclosure 1, wherein the marking portion is recessed with respect to a reference surface of the outer surface of the sidewall portion.

### Disclosure 3

The pneumatic tire according to Disclosure 1 or Disclosure 2, wherein a recessed amount of the marking portion with respect to the reference surface is not larger than 1.5 mm.

### Disclosure 4

The pneumatic tire according to any one of Disclosure 1 to Disclosure 3, wherein one to four micro projections are arranged per mm² in the second region.

### Disclosure 5

The pneumatic tire according to any one of Disclosure 1 to Disclosure 4, wherein the second region includes a portion where the plurality of micro projections are arranged so as to form closest packing in a planar view.

### Disclosure 6

The pneumatic tire according to any one of Disclosure 1 to Disclosure 5, wherein
each of the plurality of micro projections has a first maximum outer diameter in a planar view,
the rib has a maximum rib width orthogonal to a longitudinal direction thereof, and
the rib width is larger than ½ of the first maximum outer diameter.

### Disclosure 7

The pneumatic tire according to any one of Disclosure 1 to Disclosure 6, wherein the rib width is smaller than the first maximum outer diameter.

### Disclosure 8

The pneumatic tire according to any one of Disclosure 1 to Disclosure 7, wherein a maximum height of the rib with respect to the first region is 10% to 80% of a maximum height of the plurality of micro projections with respect to the first region.

### Disclosure 9

The pneumatic tire according to any one of Disclosure 1 to Disclosure 8, wherein the plurality of micro projections include a first projection that is not directly connected to the rib and a second projection that is partially connected to the rib.

### Disclosure 10

The pneumatic tire according to any one of Disclosure 1 to Disclosure 9, wherein
the rib includes a first side surface on the first region side, a second side surface on the second region side, and a top face between the first side surface and the second side surface, and
the second projection is connected only to the second side surface of the rib, or to both the second side surface and the top face.

### Disclosure 11

The pneumatic tire according to any one of Disclosure 1 to Disclosure 10, wherein the second projection is not connected to the first side surface.

### Disclosure 12

The pneumatic tire according to any one of Disclosure 1 to Disclosure 11, wherein
a reference surface is at a first height,
tips of the plurality of micro projections are at a second height below the first height,
an upper surface of the rib of the first region is at a third height below the second height, and
an upper surface of the first region is at a fourth height below the third height.

### Disclosure 13

The pneumatic tire according to any one of Disclosure 1 to Disclosure 12, wherein a base of at least one of the micro projections is spaced apart from the rib of the first region.

### Disclosure 14

The pneumatic tire according to any one of Disclosure 1 to Disclosure 13, wherein a first base of a first one of the micro projections is spaced apart from a second base of a second one of the micro projections, the first and second micro projections being adjacent to each other in the second region.

### Disclosure 15

A tire comprising:
a pair of sidewall portions, wherein
at least one of outer surfaces of the pair of sidewall portions includes at least one marking portion,
the marking portion includes:
   a first region forming a mark,
   a second region that is a background portion of the mark, and
   a fringing portion that demarcates the first region from the second region and fringes a contour of the mark,
the first region is formed as a smooth surface,
the second region is a projection-recess region where a plurality of micro projections are arranged,
the fringing portion is a rib projecting from the first region,
a reference surface is at a first height,
tips of the plurality of micro projections are at a second height below the first height,
an upper surface of the rib of the first region is at a third height below the second height,
an upper surface of the first region is at a fourth height below the third height,
each micro projection is adjacent to at least two other micro projections of the plurality of micro projections.

### Disclosure 16

The tire according to Disclosure 15, wherein a base of at least one of the micro projections is spaced apart from the rib of the first region.

### Disclosure 17

The tire according to Disclosure 15 or Disclosure 16, wherein each said micro projection touches said at least two other micro projections of the plurality of micro projections.

### Disclosure 18

The tire according to any one of Disclosure 15 to Disclosure 17, wherein a first base of a first one of the micro projections is spaced apart from a second base of a second one of the micro projections, the first and second micro projections being adjacent to each other in the second region.

### Disclosure 19

The tire according to any one of Disclosure 15 to Disclosure 18, wherein
one to four micro projections are arranged per mm² in the second region, and
the plurality of micro projections include a first projection that is not directly connected to the rib and a second projection that is partially connected to the rib.

### Disclosure 20

The tire according to any one of Disclosure 15 to Disclosure 19, wherein
the rib has a maximum width less than a maximum diameter of each of the micro projections, and
the rib has a length greater than the maximum diameter of each of the micro projections.

What is claimed is:

1. A pneumatic tire comprising:
a pair of sidewall portions, wherein
at least one of outer surfaces of the pair of sidewall portions includes at least one marking portion,
the marking portion includes:
a first region forming a mark including at least one character, at least one graphic, or at least one symbol,
a second region that is a background portion of the mark, and
a fringing portion that demarcates the first region from the second region and fringes a contour of the mark,
the first region is formed as a smooth surface,
the second region is a projection-recess region where a plurality of micro projections are arranged, and
the fringing portion is a rib projecting from the first region.

2. The pneumatic tire according to claim 1, wherein the marking portion is recessed with respect to a reference surface of the outer surface of the sidewall portion.

3. The pneumatic tire according to claim 2, wherein a recessed amount of the marking portion with respect to the reference surface is not larger than 1.5 mm.

4. The pneumatic tire according to claim 1, wherein one to four micro projections are arranged per mm² in the second region.

5. The pneumatic tire according to claim 1, wherein the second region includes a portion where the plurality of micro projections are arranged so as to form closest packing in a planar view.

6. The pneumatic tire according to claim 1, wherein
each of the plurality of micro projections has a first maximum outer diameter in a planar view,
the rib has a maximum rib width orthogonal to a longitudinal direction thereof, and
the rib width is larger than ½ of the first maximum outer diameter.

7. The pneumatic tire according to claim 6, wherein the maximum rib width is smaller than the first maximum outer diameter.

8. The pneumatic tire according to claim 1, wherein a maximum height of the rib with respect to the first region is 10% to 80% of a maximum height of the plurality of micro projections with respect to the first region.

9. The pneumatic tire according to claim 1, wherein the plurality of micro projections include a first projection that is not directly connected to the rib and a second projection that is partially connected to the rib.

10. The pneumatic tire according to claim 9, wherein
the rib includes:
a first side surface on the first region side,
a second side surface on the second region side, and
a top face between the first side surface and the second side surface, and
the second projection is connected only to the second side surface of the rib, or to both the second side surface and the top face.

11. The pneumatic tire according to claim 10, wherein the second projection is not connected to the first side surface.

12. The pneumatic tire according to claim 1, wherein
a reference surface is at a first height,
tips of the plurality of micro projections are at a second height below the first height,
an upper surface of the rib of the first region is at a third height below the second height, and
an upper surface of the first region is at a fourth height below the third height.

13. The pneumatic tire according to claim 1, wherein a base of at least one of the micro projections is spaced apart from the rib of the first region.

14. The pneumatic tire according to claim 1, wherein a first base of a first one of the micro projections is spaced apart from a second base of a second one of the micro projections, the first and second micro projections being adjacent to each other in the second region.

15. A tire comprising:
a pair of sidewall portions, wherein
at least one of outer surfaces of the pair of sidewall portions includes at least one marking portion,
the marking portion includes:
a first region forming a mark,
a second region that is a background portion of the mark, and
a fringing portion that demarcates the first region from the second region and fringes a contour of the mark,
the first region is formed as a smooth surface,
the second region is a projection-recess region where a plurality of micro projections are arranged,
the fringing portion is a rib projecting from the first region,
a reference surface is at a first height,
tips of the plurality of micro projections are at a second height below the first height,
an upper surface of the rib of the first region is at a third height below the second height,
an upper surface of the first region is at a fourth height below the third height,
each micro projection is adjacent to at least two other micro projections of the plurality of micro projections.

16. The tire according to claim 15, wherein a base of at least one of the micro projections is spaced apart from the rib of the first region.

17. The tire according to claim 15, wherein each said micro projection touches said at least two other micro projections of the plurality of micro projections.

18. The tire according to claim 15, wherein a first base of a first one of the micro projections is spaced apart from a second base of a second one of the micro projections, the first and second micro projections being adjacent to each other in the second region.

19. The tire according to claim 15, wherein
one to four micro projections are arranged per mm² in the second region, and
the plurality of micro projections includes a first projection that is not directly connected to the rib and a second projection that is partially connected to the rib.

20. The tire according to claim 15, wherein
the rib has a maximum width less than a maximum diameter of each of the micro projections, and
the rib has a length greater than the maximum diameter of each of the micro projections.
